(19) United States
(12) Patent Application Publication
(10) Pub. No.: US 2022/0044326 A1
(43) Pub. Date: Feb. 10, 2022

(54) SYSTEMS AND METHODS FOR AUTOMATED SYSTEM CONTROL BASED ON ASSESSED MINDSETS

(71) Applicant: JPMORGAN CHASE BANK, N.A., New York, NY (US)

(72) Inventor: Ankur SAMBHAR, Thane West (IN)

(21) Appl. No.: 17/397,268

(22) Filed: Aug. 9, 2021

(30) Foreign Application Priority Data
Aug. 7, 2020 (IN) 202011033923

(51) Int. Cl. G06Q 40/06; G06Q 40/02

(52) U.S. Cl. CPC G06Q 40/06; G06Q 40/025

(57) ABSTRACT

Systems and methods for automated system control based on assessed mindsets are disclosed. A method for automated system control may include a behavior tracking computer program: (1) receiving individual information for an individual from a plurality of sources; (2) generating an individual profile based on the individual information, wherein the individual profile identifies at least one item that impacts the individual's ability to perform a task; (3) receiving an event feed from an event source; (4) identifying an event in the event feed; (5) determining that the event is related to the item in the individual profile; (6) determining a risk level associated with the event; (7) determining that the risk level exceeds a threshold; (8) and controlling a downstream system based on the determination that the risk level exceeds a threshold.

### RELATED APPLICATIONS

This application claims priority to, and the benefit of, Indian Patent Application Number 202011033923, filed Aug. 7, 2020, the disclosure of which is hereby incorporated, by reference, in its entirety.

### BACKGROUND OF THE INVENTION

### 1. Field of the Invention

Embodiments relate generally to systems and methods for automated system control based on assessed mindsets.

### 2. Description of the Related Art

Systems are not capable of determining life events for employees, such as traders and/or portfolio managers, that could affect their decision-making capabilities, and lead to financial and reputational losses. Existing solutions are reactive—they check the behavior of the individuals based on past records, and generate a pattern. If there is any deviation from the pattern, it is highlighted.

### SUMMARY OF THE INVENTION

Systems and methods for automated system control based on assessed mindsets are disclosed. In one embodiment, a method for automated system control may include: (1) receiving, by a behavior tracking computer program, individual information for an individual from a plurality of sources; (2) generating, by the behavior tracking computer program, an individual profile based on the individual information, wherein the individual profile identifies at least one item that impacts the individual's ability to perform a task; (3) receiving, by the behavior tracking computer program, an event feed from an event source; (4) identifying, the by behavior tracking computer program, an event in the event feed; (5) determining, by the behavior tracking computer program, that the event is related to the item in the individual profile; (6) determining, by the behavior tracking computer program, a risk level associated with the event; (7) determining, by the behavior tracking computer program, that the risk level exceeds a threshold; (8) and controlling, by the behavior tracking computer program, a downstream system based on the determination that the risk level exceeds a threshold.

In one embodiment, the individual information may include a nationality, a hometown, a home country, family information, family residence information, and/or investment information.

In one embodiment, the individual information may include a political interest and/or a social interest.

In one embodiment, the event source may include social media feeds, news feeds, politics feeds, weather feeds, and/or transaction feeds.

In one embodiment, the threshold may be based on prior events.

In one embodiment, the behavior tracking computer program may control the downstream system to restrict an action by the individual.

In one embodiment, the risk level may be based on a sentiment of the event.

In one embodiment, the behavior tracking computer program may encrypt the item in the individual profile and the event using homomorphic encryption and may determine that the event may be related to the item in the individual profile by comparing the encrypted item to the encrypted event.

In one embodiment, the behavior tracking computer program may generate a hash of the item in the individual profile, may generate a hash of the event, and may determine that the event may be related to the item in the individual profile by comparing the hash of the item to the hash of the event.

In one embodiment, the risk level may be based on a severity of the event.

According to another embodiment, an electronic device may include a computer processor and a memory storing a behavior tracking computer program. When executed by the computer processor, the behavior tracking computer program may cause the behavior tracking computer program to: receive individual information for an individual from a plurality of sources; generate an individual profile based on the individual information, wherein the individual profile identifies at least one item that impacts the individual's ability to perform a task; receive an event feed from an event source; identify an event in the event feed; determine that the event is related to the item in the individual profile; determine a risk level associated with the event; determine that the risk level exceeds a threshold; and control a downstream system based on the determination that the risk level exceeds a threshold.

In one embodiment, the individual information may include a nationality, a hometown, a home country, family information, family residence information, and/or investment information.

In one embodiment, the individual information may include a political interest and/or a social interest.

In one embodiment, the event source may include social media feeds, news feeds, politics feeds, weather feeds, and/or transaction feeds.

In one embodiment, the threshold may be based on prior events.

In one embodiment, the behavior tracking computer program controls the downstream system to restrict an action by the individual.

In one embodiment, the risk level may be based on a sentiment of the event.

In one embodiment, the behavior tracking computer program may encrypt the item in the individual profile and the event using homomorphic encryption and may determine that the event is related to the item in the individual profile by comparing the encrypted item to the encrypted event.

In one embodiment, the behavior tracking computer program may generate a hash of the item in the individual profile, may generate a hash of the event, and may determine that the event is related to the item in the individual profile by comparing the hash of the item to the hash of the event.

In one embodiment, the risk level may be based on a severity of the event.

### BRIEF DESCRIPTION OF THE DRAWINGS

In order to facilitate a fuller understanding of the present invention, reference is now made to the attached drawings. The drawings should not be construed as limiting the present invention but are intended only to illustrate different aspects and embodiments.

FIG. 1 illustrates a system for automated system control based on assessed mindsets according to one embodiment.

FIG. 2 depicts a method for automated system control based on assessed mindsets according to one embodiment.

### DETAILED DESCRIPTION OF PREFERRED EMBODIMENTS

Embodiments relate generally to systems and methods for automated system control based on assessed mindsets.

Embodiments may assess the mindset of individual, such as a trader, a portfolio manager, etc. by learning about the individual's personal life events. For example, the system may receive data from the individual's social media profiles such as Facebook, Twitter, LinkedIn, etc. Embodiments may also monitor individual spending, receive feeds from the individual's Internet of Things (“IoT”) devices, etc. From these inputs, the system may learn the individual's preferences and generate patterns around those preferences.

The decision making may be based on rules that may be configured in the system. The rules engine may also use machine learning based on prior decisions and may suggest and/or execute actions without human interaction, or with minimal human interaction. For example, embodiments may consider the action taken from a prior alert, the scenarios in which the alert was overridden, etc. In addition, this may allow the engine to adjust the threshold necessary to generate an alert. User may also manually set the rules and threshold using the graphical user interface (GUI).

It should be noted that although this description may be in the context of a trader or a portfolio manager, the disclosure is not so limited. The mindset of any individual that may perform a task on behalf of another may be assessed as is necessary and/or desired.

If the system identifies a deviation in the individual's behavior, or captures a significant life event in the individual's life, embodiments may generate an alert. The premise of the alert is that if the individual is going through a rough patch in his/her personal life, then there are very high chances that he/she may not make the best decision. Embodiments may restrict the execution of that decision by requiring oversight by a supervisor, or may completely restrict the individual's ability to execute the decision on a downstream system.

Thus, instead of being reactive to an anomalous business decision, embodiments proactively generate an alert that may initiate additional checks and controls on the individual's authority to take an action. Embodiments may also capture if the individual is going through any financial crisis or spending much more than his/her declared source of income. Embodiments may also generate an alert if an individual's personal support toward certain ideologies that could lead to terror funding, money laundering, etc. are detected.

Embodiments may generate a generic pattern across the individual's response to any new financial, social or economic changes.

For example, if there is a death of a member in the individual's family, or of a close friend, this event may generate an alert that may prevent the individual from trading for a certain amount of time, may more closely monitor trades, etc. Embodiments may identify outlying trades and track them against the individual's general behavior.

Embodiments may provide at least some of the following benefits: (1) a proactive system that generates an alert about the trading capability of individual; (2) reduces or avoids financial and reputational loss to a financial institution; and (3) identifies individual, and other personnel, undergoing significant life events and for counselling and support.

An illustrative, non-limiting use case is as follows. Charlie is a trader with ABC Bank. Charlie is active on social media, and consents to ABC bank receiving a feed from his social media accounts. A behavior tracking computer program may check the individual profile of Charlie on various social media platforms through name, image comparison, etc. If some of these accounts are not already onboarded for tracking, the behavior tracking computer program may seek consent to receive data from these additional accounts. The behavior tracking computer program may receive and consume data from the social media accounts on which Charlie is active, and from other sources such as political news, weather, financial news, etc.

For example, from a weather feed and from knowing where Charlie's family lives, the behavior tracking computer program may determine there is a hurricane threatening an area where Charlie's family lives, and based on Charlie's social media posts, determines that Charlie is worried about his family. The behavior tracking computer program may then put the trading system in cautionary mode, identifying that Charlie may not be capable of making the best business decisions. This may restrict Charlie's ability to trade, may reduce the dollar amount of trades, may reduce the hours that Charlie may trade, may have another employee approve Charlie's trades, etc.

As another example, based on Charlie's social media posts, the behavior tracking computer program may determine that Charlie is very patriotic. From a news feed, the behavior tracking computer program may determine that Charlie's country is being attacked by a country that is home to many companies with which Charlie trades. The behavior tracking computer program may then generate an alert that Charlie might not be in the state to take the correct decision and put the system in cautionary mode, and may restrict Charlie's ability to trade, may reduce the dollar amount of trades, may reduce the hours that Charlie may trade, may have another employee approve Charlie's trades, etc.

In embodiments, the alerts may be analyzed by a risk/compliance team to determine that the concern is genuine, or if any additional actions are necessary.

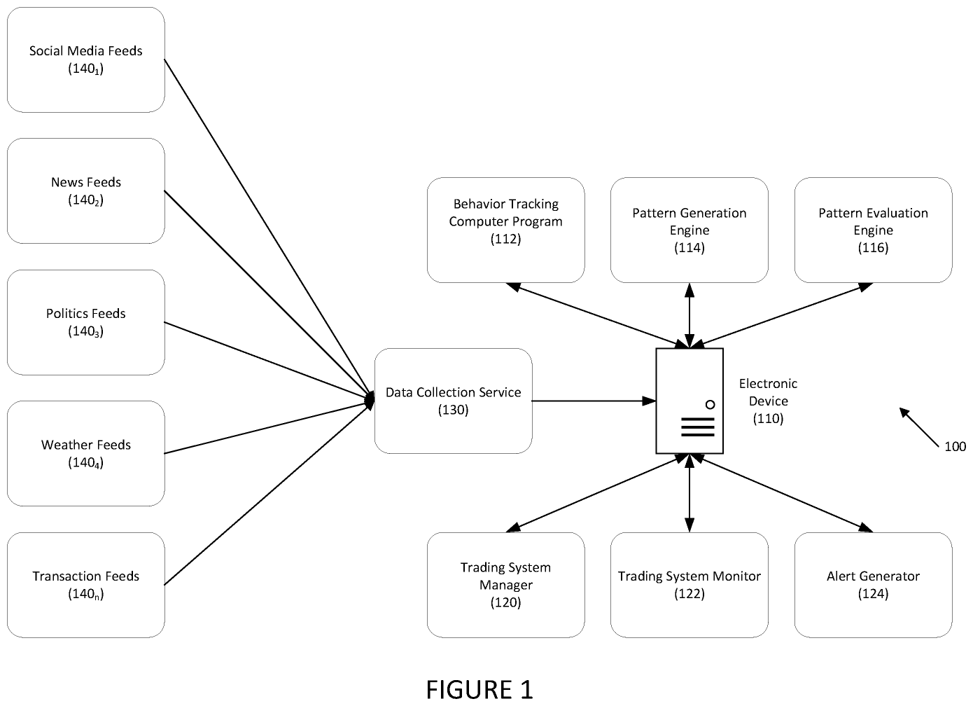

Referring to FIG. 1, an exemplary system for assessing individual mindsets is disclosed according to one embodiment. System 100 may include electronic device 110 that may execute behavior tracking computer program 112, pattern generation engine 114, and pattern evaluation engine 116. In one embodiment, electronic device 110 may be a server, a workstation, a computer (e.g., workstation, desktop, laptop, notebook, tablet, etc.) a smart device (e.g., a smart phone), an Internet of Things (IoT) appliance, etc.

In one embodiment, behavior tracking computer program 112, pattern generation engine 114, and pattern evaluation engine 116 may be part of the same computer program or application, or they may be separate computer programs or applications.

Electronic device 110 may further communicate with one or more downstream system, including, for example, trading management system 120, trading system monitor 122, alert generator 124, etc. Additional and/or different downstream systems may be provided as is necessary and/or desired.

In one embodiment, the downstream systems may include controls that may allow or disable an individual's ability to execute an action, such as execute a trade.

System 100 may further include data collection service 130 that may interface with one or more event feeds 140, such as social media feeds 140₁, news feeds 140₂, politics feeds 140₃, weather feeds 140₄, transaction feeds 140ₙ, etc. Feeds 140 may be sourced external to the organization or internal to the organization. Additional, fewer, or different feeds 140 may be used as is necessary and/or desired.

Data collection service 130 may receive data from event feed 140, and from the individual's digital footprint. For example, data collection service 130 may first check the digital footprint for which the individual has given consent, such as consent to pull the data from certain social media feeds 140₁, but not from other feeds 140.

Data collection service 130 may periodically pull data from event feeds 140; in another embodiment, data collection service 130 may periodically receive data from data collection service 130.

In one embodiment, data from data collection service 130 may be provided to pattern generation engine 114, which may generate patterns for one or more individuals. Pattern generation engine 114 may generate a pattern for the individual based on the data collected. Pattern generation engine 114 may include predictive models that may predict behavior, and may generate a knowledge graph for the potential outcomes.

Pattern evaluation engine 116 may evaluate the generated pattern against a standard pattern for the individual, or that for a typical individual. Pattern evaluation engine 116 may identify any deviations from the standard pattern based on the collected data and predicted outcomes. Each of the potential outcome will be evaluated along with an associated risk.

Based on the pattern evaluation, pattern evaluation engine 116 may generate an alert using the alert engine if, for example, the potential is above a configured threshold. Alert generator 124 may generate one or more alert to notify the various systems that the individual may access. This may put the system in a “cautionary mode” to reduce any risk.

The alert may inform trading system monitor 122 to monitor the individual's activities, to restrict the individual's authority to conduct trades, etc., using trading management system 120. Trading system monitor 122 may further evaluate the alert to determine if the alert is genuine or if any other actions should be taken. For example, the trading system monitor 122 may not allow the individual to make the trade above a certain amount, could ask for an additional approval for putting in the trades, etc.

In one embodiment, a distributed ledger may be used to collect data from the event feeds, to write any alerts, to write any actions taken, etc. In embodiments, the data may be written to a data store, a distributed ledger, etc. For example, a distributed ledger may be leveraged to source the data by participating on the same distributed ledger, which may be a private/permissioned distributed ledger or a public distributed ledger. Data from the sources on the same distributed ledger may be used to analyze and generate patterns.

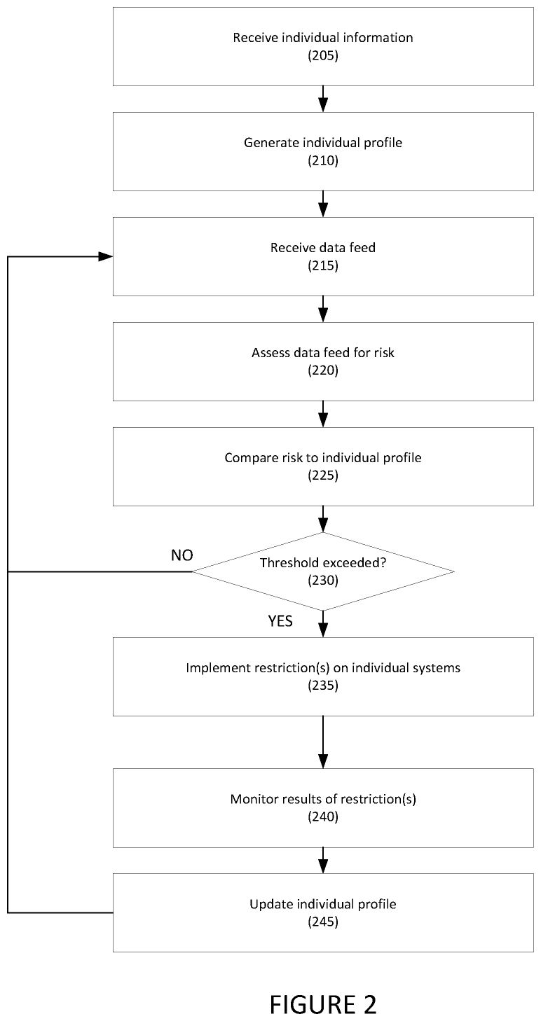

Referring to FIG. 2, a method for assessing individual mindsets is disclosed according to an embodiment.

In step 205, a behavior tracking computer program may receive individual information. In one embodiment, the behavior tracking computer program may receive information regarding an individual's social media accounts, nationality, hometown or country, locations where the individual's family and/or relatives may live, investments, interests, etc.

In one embodiment, the behavior tracking computer program may receive authorization to access private feeds for the individual, such as the individual's social media postings.

In one embodiment, individual information may be provided manually by the individual. For example, the behavior tracking computer program present the individual with a questionnaire and the individual may provide information regarding family locations, property interests and locations, investments, etc. In one embodiment, the behavior tracking computer program may further receive individual location data from an individual electronic device so that it can determine locations where the individual travels.

In one embodiment, to preserve privacy, the individual information may be encrypted, may be hashed and stored, etc. For example, homomorphic encryption may be used so that items in the individual information may be compared to event in an event feed without decrypting the individual information.

In step 210, the behavior tracking computer program may generate individual profile based on the individual information. The individual profile may be created based on the details shared by the individual and may be augmented with the details captured from the individual's digital footprint, such as location data. The individual profile may identify areas, such as social and/or economic interests, that may impact the individual's ability to perform a task. For example, information about the individual's family, political interests, significant investments, social interests, etc. may be identified and included in the individual profile.

In step 215, the behavior tracking computer program may receive events from one or more event feed. Examples of event feeds may include social media feeds, news feeds, politics feeds, weather feeds, transaction feeds, etc. Any feed may be received as is necessary and/or desired.

In one embodiment, the event feeds may be received by a data collection service, which may interface with the event feeds. In one embodiment, the data collection service may be authorized to access non-public feeds for the individual.

In step 220, the behavior tracking computer program may assess the event in the event feed(s) for risks in view of the individual's profile. For example, the behavior tracking computer program may determine a sentiment for an event in the event feed to determine if it is something that may impact the individual's ability to perform his or her job.

In embodiments, the behavior tracking computer program may overlay the event feed with the individual profile data to determine if there is a correlation and to assess any risk. For example, using natural language processing, the behavior tracking computer program may determine the sentiment of the event and assess any impact of it on the individual based on the individual profile. The event in itself could be labeled as high risk but might not be of any impact to individual. For example, if there is a hurricane event, the behavior tracking computer program may determine whether the individual has an interest in the area impacted by the hurricane, such as property, family, etc. If the individual does not have an interest in the area, the behavior tracking computer program may not identify a correlation. If the individual does have an interest in the area, the behavior tracking computer program may determine a risk, which may depend on the severity of the hurricane, the type of interest (e.g., property, family, etc.), etc. and may assign a level of risk to the event.

The risk may be quantified based on various models, such as the impact of the event, the severity of the event, a probability that the event turns to risk, sentiments associated with event, scope of the impact of the event, etc. In addition, individual association with the impact of the event may be considered.

In one embodiment, the behavior tracking computer program may monitor the individual's activities (e.g., work activities, social media posting, spending, communications, etc.) to identify an event or pattern that may indicate a risk. For example, if the individual is absent from work for several days following an event, the behavior tracking computer program may identify this as a risk. As another example, if the individual is spending more than usual, posting on social media, etc., this may be a pattern that indicates risk.

In one embodiment, if the items in the individual profile are stored as hashes, certain data from the event feed (e.g., location, investment type, etc.) may be hashed and then the hashed may be compared.

In another embodiment, if the items in the individual profile are encrypted, certain data from the event feed may be encrypted using homomorphic encryption so that the encrypted values may be compared.

In step 225, the behavior tracking computer program may evaluate the risk for the event to determine if the risk is above a threshold for taking an action. In embodiments, the threshold may be set by the individual via a graphical individual interface, by machine learning based on prior scenarios, etc. The level of risk may be based on the amount of correlation between the event and the individual information in the individual profile.

Various patterns of machine learning may be leveraged to determine the appropriate level of threshold. For example, a machine learning engine may learn from past events for threshold and corresponding actions. Embodiments may further use clustering patterns to determine the outlier behavioral patterns from individual.

In one embodiment, techniques such as single-point probability analysis, quantitative risk analysis, Monte Carlo, sensitivity analysis, decision trees, etc. may be used to evaluate the risk and determine if the risk exceeds the threshold.

In embodiments, the risk model may take the inputs, such as the event, the individual profile, and any other data points that system has gathered through the historic processing. The behavior tracking computer program may apply a risk modeling technique to determine the risk associated with an event and verify it against the defined threshold to trigger the appropriate level of alert. Depending on the risk severity of the risk, different levels of alert may be generated by the system. For example, the behavior tracking computer program may lock down one or more downstream systems with individual having no ability to take an action, it may require a higher level of security, it may require supervisor approval of actions, etc. Embodiments may use multiple risk modeling methods in parallel, and may use a combination of the results of each modeling method to determine the average risk factor, a weighted risk factor, etc.

In step 230, if the threshold is exceeded, indicating a risk that the individual may not perform his or her job properly, in step 235, the behavior tracking computer program may cause one or more restriction to be implemented before the individual can take an action. Examples of restrictions may include requiring supervisor approval to execute a transaction above a certain amount, restricting activities involving an entity, a country, deactivating individual access to one or more system, etc.

In step 240, the behavior tracking computer program may monitor the results of the restriction. For example, the behavior tracking computer program may determine whether or not the restriction has been effective, whether more stringent or less stringent restrictions are necessary, etc.

In one embodiment, the behavior tracking computer program may monitor the individual's activities to see if the individual behaves differently based on the risk.

In step 245, the behavior tracking computer program may update individual profile based on the results of the restriction. For example, the behavior tracking computer program may update the individual profile with information as to whether or not the restriction was successful, whether the risk impacted the individual's behavior, etc.

If, in step 230, the threshold is not breached, the behavior tracking computer program may return to step 215.

Although multiple embodiments have been described, it should be recognized that these embodiments are not exclusive to each other, and that features from one embodiment may be used with others.

Hereinafter, general aspects of implementation of the systems and methods of the invention will be described.

The system of the invention or portions of the system of the invention may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement the invention may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

The processing machine used to implement the invention may utilize a suitable operating system.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further embodiment of the invention, be performed by a single component. Further, the processing performed by one distinct component as described above may be performed by two distinct components. In a similar manner, the memory storage performed by two distinct memory portions as described above may, in accordance with a further embodiment of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity; i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the invention. Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors of the invention.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention.

Accordingly, while the present invention has been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method for automated system control, comprising:
receiving, by a behavior tracking computer program, individual information for an individual from a plurality of sources;
generating, by the behavior tracking computer program, an individual profile based on the individual information, wherein the individual profile identifies at least one item that impacts the individual's ability to perform a task;
receiving, by the behavior tracking computer program, an event feed from an event source;
identifying, the by behavior tracking computer program, an event in the event feed;
determining, by the behavior tracking computer program, that the event is related to the item in the individual profile;
determining, by the behavior tracking computer program, a risk level associated with the event;
determining, by the behavior tracking computer program, that the risk level exceeds a threshold; and
controlling, by the behavior tracking computer program, a downstream system based on the determination that the risk level exceeds a threshold.

2. The method of claim 1, wherein the individual information comprises a nationality, a hometown, a home country, family information, family residence information, and/or investment information.

3. The method of claim 1, wherein the individual information comprises a political interest and/or a social interest.

4. The method of claim 1, wherein the event source comprises social media feeds, news feeds, politics feeds, weather feeds, and/or transaction feeds.

5. The method of claim 1, wherein the threshold is based on prior events.

6. The method of claim 1, wherein the behavior tracking computer program controls the downstream system to restrict an action by the individual.

7. The method of claim 1, wherein the risk level is based on a sentiment of the event.

8. The method of claim 1, wherein the behavior tracking computer program encrypts the item in the individual profile and the event using homomorphic encryption and determines that the event is related to the item in the individual profile by comparing the encrypted item to the encrypted event.

9. The method of claim 1, wherein the behavior tracking computer program generates a hash of the item in the individual profile, generates a hash of the event, and determines that the event is related to the item in the individual profile by comparing the hash of the item to the hash of the event.

10. The method of claim 1, wherein the risk level is based on a severity of the event.

11. An electronic device, comprising:
a computer processor; and
a memory storing a behavior tracking computer program;
wherein, when executed by the computer processor, the behavior tracking computer program causes the behavior tracking computer program to:
receive individual information for an individual from a plurality of sources;
generate an individual profile based on the individual information, wherein the individual profile identifies at least one item that impacts the individual's ability to perform a task;
receive an event feed from an event source;
identify an event in the event feed;
determine that the event is related to the item in the individual profile;
determine a risk level associated with the event;
determine that the risk level exceeds a threshold; and
control a downstream system based on the determination that the risk level exceeds a threshold.

12. The electronic device of claim 11, wherein the individual information comprises a nationality, a hometown, a home country, family information, family residence information, and/or investment information.

13. The electronic device of claim 11, wherein the individual information comprises a political interest and/or a social interest.

14. The electronic device of claim 11, wherein the event source comprises social media feeds, news feeds, politics feeds, weather feeds, and/or transaction feeds.

15. The electronic device of claim 11, wherein the threshold is based on prior events.

16. The electronic device of claim 11, wherein the behavior tracking computer program controls the downstream system to restrict an action by the individual.

17. The electronic device of claim 11, wherein the risk level is based on a sentiment of the event.

18. The electronic device of claim 11, wherein the behavior tracking computer program encrypts the item in the individual profile and the event using homomorphic encryption and determines that the event is related to the item in the individual profile by comparing the encrypted item to the encrypted event.

19. The electronic device of claim 11, wherein the behavior tracking computer program generates a hash of the item in the individual profile, generates a hash of the event, and determines that the event is related to the item in the individual profile by comparing the hash of the item to the hash of the event.

20. The electronic device of claim 11, wherein the risk level is based on a severity of the event.
